(19) United States
(12) Patent Application Publication
(10) Pub. No.: US 2024/0134672 A1
(43) Pub. Date: Apr. 25, 2024

(54) PROXY-BASED AGENT INSTALLATIONS IN DATA CENTERS

(71) Applicant: VMWARE, INC., Palo Alto, CA (US)

(72) Inventors: LEENA SHUKLENDU SOMAN, Pune (IN); RUSHIT NILAY DESAI, Pune (IN); SUSHANT SHARAD RAVALE, Pune (IN); SACHIN SHINDE, Pune (IN); ELANGO MUTHU, Pune (IN)

(21) Appl. No.: 18/086,715

(22) Filed: Dec. 22, 2022

(30) Foreign Application Priority Data
Oct. 24, 2022 (IN) 202241060685

(51) Int. Cl. G06F 9/455; G06F 8/65

(52) U.S. Cl. CPC G06F 9/45558; G06F 8/65; G06F 2009/4557; G06F 2009/45595

(57) ABSTRACT

An example method may include determining, by a first program running on a first compute node, that a shared datastore connected to the first compute node includes address information for downloading an agent installer and proxy information for accessing a proxy server. The address information and the proxy information may be stored in the shared datastore by a second program running on a second compute node based on a user-configured input. Further, the method may include reading, by the first program, the proxy information and the address information from the shared datastore. Furthermore, the method may include downloading, by the first program, the agent installer from a destination server corresponding to the address information via a proxy server associated with the proxy information. Further, the method may include executing, by the first program, the agent installer to install the agent on the first compute node.

### RELATED APPLICATIONS

Benefit is claimed under 35 U.S.C. 119(a)-(d) to Foreign Application Serial No. 202241060685 filed in India entitled “PROXY-BASED AGENT INSTALLATIONS IN DATA CENTERS”, on Oct. 25, 2022, by VMware, Inc., which is herein incorporated in its entirety by reference for all purposes.

### TECHNICAL FIELD

The present disclosure relates to computing environments, and more particularly to methods, techniques, and systems to install agents in compute nodes of a data center based on proxy information.

### BACKGROUND

In computing environments, a host computing system may execute workloads running herein. An example host computing system may be a physical computer. Example workloads may include virtual machines and/or containers. A virtual machine can be a software implementation of the physical computer that runs an operating system (OS) and virtual machine applications. The container may be an instance of a user-space running containerized applications within the OS of the virtual machine. Further, the host computing system and/or the workloads may execute various applications. Monitoring and/or managing such applications and corresponding OS performance may include deploying or installing various agents such as monitoring agents, security agents, and the like on the host computing system and/or on the workloads running on the host computing system. For example, agents deployed on a virtual machine may monitor and manage the OS and applications deployed on that virtual machine.

### BRIEF DESCRIPTION OF THE DRAWINGS

FIG. 1 is a block diagram of an example computing environment, depicting a first program to install an agent on a compute node based on address information and proxy information;

FIG. 2 is a block diagram of an example computing environment, depicting a first program to install an agent on a virtual machine based on address information and proxy information;

FIG. 3 is a flow diagram illustrating an example computer-implemented method for installing an agent on a first compute node in a data center;

FIG. 4 is a flow diagram illustrating another example computer-implemented method for installing an agent on a virtual machine in a data center; and

FIG. 5 is a block diagram of an example compute node including non-transitory computer-readable storage medium storing instructions to install an agent on a compute node.

The drawings described herein are for illustrative purposes and are not intended to limit the scope of the present subject matter in any way.

### DETAILED DESCRIPTION

Examples described herein may provide an enhanced computer-based and/or network-based method, technique, and system to install an agent in a compute node of a computing environment. The paragraphs to present an overview of the computing environment, existing methods to install the agent in the compute node, and drawbacks associated with the existing methods.

The computing environment may be a physical computing environment (e.g., an on-premise enterprise computing environment or a physical data center) and/or a virtual computing environment (e.g., a cloud computing environment, a virtualized environment, and the like). The virtual computing environment may be a pool or collection of cloud infrastructure resources designed for enterprise needs. The resources may be a processor (e.g., central processing unit (CPU)), memory (e.g., random-access memory (RAM)), storage (e.g., disk space), and networking (e.g., bandwidth). Further, the virtual computing environment may be a virtual representation of the physical data center, complete with servers, storage clusters, and networking components, all of which may reside in virtual space being hosted by one or more physical data centers. Example virtual computing environment may include different compute nodes (e.g., physical computers, virtual machines, and/or containers). For example, the virtual computing environment may include multiple physical computers executing different workloads such as virtual machines, containers, and the like running therein. Example compute nodes may execute different types of applications.

In such computing environments, organizations may have a need to monitor performance of their information technology resources (i.e., components in the computing environment). Monitoring may be accomplished using agents on the monitored compute nodes (e.g., virtual machines (VM), physical machines (PM), containers, or the like). As used herein, the term “agent” refers to software installed on a compute node (e.g., virtual or physical) that provides an interface to enable remote control of the compute node for execution of commands, scripts, and/or other code. The agents monitor designated aspects of the compute node (e.g., hardware, software, and/or firmware aspects) and report data related to the monitored aspects to a monitoring server. In some examples, the monitoring server processes and/or formats the monitored aspects and presents the results to an administrator or another user (e.g., a person) associated with the compute nodes.

Cloud environments are dynamic by nature. Resources, such as virtual machines (e.g., Windows and/or Linux servers) and/or application services, may be created, used, moved, and/or destroyed with relatively high frequency. In such dynamic environments, monitoring the resources (e.g., virtual machines, applications, services, and the like) can be challenging because, among other things, new resources are often created, resources change their location, and/or the configurations of the resources change. Such changes result in changes to monitoring requirements for the resources.

The agents may be installed on the compute nodes on cloud environments (e.g., vCenter, a cloud platform offered by VMware), for example, to monitor the performance of applications running on the compute nodes, to monitor inbound/outbound network traffic on the compute nodes, for security purposes, and the like. Because the monitoring agents are resource intensive, virtual infrastructure administrators install the monitoring agents on the compute nodes running important services (e.g., web servers, application servers, database servers, application components, and so on) that need to be monitored. In some existing methods, the virtual infrastructure administrators manually install and configure the monitoring agents on the compute nodes with services to be monitored. Because virtual environments are dynamic, applications (e.g., multi-tiered applications) and services may be scaled out automatically (e.g., by adding additional resources, services, applications, and the like.). The automatic scaling of the applications and the services may require the installation of new monitoring agent(s) (e.g., one or more third party agents) across the compute nodes to monitor or execute the applications and services.

In some existing methods, one way to install an agent in the compute nodes (e.g., virtual machines managed by the vCenter) is to login to each virtual machine using administrator credentials, and then ensure that proxy details are added on the virtual machine to access the internet uniform resource locator (URL) to download the agent installer. Further, the agent installer may be downloaded using the URL and trigger the install operation on the downloaded installer to install the agent. This installation process may have to be executed by logging into each virtual machine using admin/root credentials and hence may not be possible to automate or scale the installation process for multiple virtual machines.

Examples described herein may automate the process of installing agents on compute nodes without manual intervention. In an example, a computer-implemented method may be provided to install an agent on a compute node of a data center based on address information (e.g., URL) and proxy information. The method includes determining, by a first program running on a first compute node, that a shared datastore connected to the first compute node includes address information for downloading an agent installer and proxy information for accessing a proxy server. The address information and the proxy information may be stored in the shared datastore by a second program running on a second compute node based on a user-configured input. In response to determining that the shared datastore includes the address information and the proxy information, the method may include reading, by the first program, the proxy information and the address information from the shared datastore. Further, the method includes downloading, by the first program, the agent installer from a destination server corresponding to the address information via a proxy server associated with the proxy information. Furthermore, the method includes initiating, by the first program, an execution of the agent installer to install the agent on the first compute node.

In the following description, for purposes of explanation, numerous specific details are set forth in order to provide a thorough understanding of the present techniques. However, the example apparatuses, devices, and systems, may be practiced without these specific details. Reference in the specification to “an example” or similar language means that a particular feature, structure, or characteristic described may be included in at least that one example but may not be in other examples.

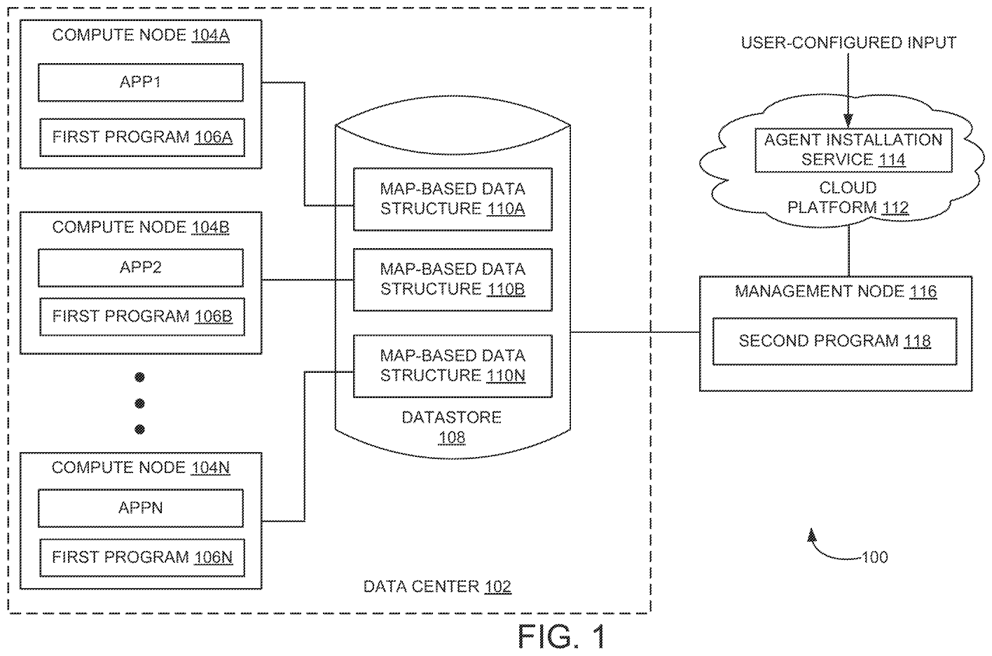

FIG. 1 is a block diagram of an example computing environment 100, depicting a first program (e.g., 106A) to install an agent on a compute node 104A based on address information (e.g., URL) and proxy information. Example computing environment 100 may be a networked computing environment such as an enterprise computing environment, a cloud computing environment, a virtualized environment, a cross-cloud computing environment, or the like. An example cloud computing environment is VMware vSpheree. As shown in FIG. 1, example computing environment 100 may include a data center 102. Further, data center 102 may include multiple compute nodes 104A-104N to execute corresponding applications app1-appN. Furthermore, each of compute nodes 104A-104N executes corresponding first programs 106A-106N to install agents on corresponding compute nodes 104A-104N to monitor health and security of compute nodes 104A-104N.

Example compute nodes 104A-104N may include, but not limited to, physical host computing systems, virtual machines running on the physical host computing systems, containers running on the physical host computing systems, or the like. The virtual machines, in some embodiments, may operate with their own guest operating systems on a physical computing device using resources of the physical computing device virtualized by virtualization software (e.g., a hypervisor, a virtual machine monitor, and the like). A container is a data computer node that runs on top of a host operating system without the need for a hypervisor or separate operating system.

Further, computing environment 100 includes a management node 116 executing a second program 118. Management node 116 may refer to a physical host computing system or a virtual appliance that provides a service to compute nodes 104A-104N or applications app1-appN running on respective compute nodes 104A-104N. Further, compute nodes 104A-104N may be managed by a centralized management platform executing centralized management services that may be interconnected to manage the resources centrally in computing environment 100. Example centralized management service may be enabled by VMware vCenter, an advanced server management software that provides a centralized platform for controlling VMware vSphere environments.

Further, data center 102 includes a shared datastore 108. In an example, shared datastore 108 may include map-based data structures 110A-110N to store information. A map-based data structure may refer to a data structure that stores information as key-value pairs in an array. Map-based data structures 110A-110N (e.g., “GuestInfo” variables) may act as a means of secure communication between respective compute nodes 104A-104N and management node 116.

In an example, shared datastore 108 may be accessible to or shared between compute nodes 104A-104N and management node 116. For example, management node 116 may communicate with compute nodes 104A-104N in data center 102 using a certificate-based authentication to read/write data to shared datastore 108. Furthermore, management node 116 is connected to a cloud-based agent installation service 114 in a cloud platform 112 (i.e., an operating system and hardware of a server in an Internet-based data center). In some examples, management node 116 may securely communicate with cloud-based agent installation service 114 using access tokens (e.g., application programming interface (API) tokens). An access token may include information required to allow management node 116 to access information on cloud platform 112.

During operation, cloud-based agent installation service 114 may enable a user to configure agent installation information indicating agents that have to be installed on a target compute node (e.g., 104A). Further, cloud-based agent installation service 114 may enable the user to configure proxy information (e.g., a proxy setting) to be used for compute node 104A. For compute nodes 104A-104N deployed in computing environment 100, compute nodes 104A-104N may need to have proxy-based access to outside internet during the installation. The proxy information may limit the exposure of compute nodes 104A-104N to the public internet and limit the access to compute nodes 104A-104N from the public internet. Based on the principle of least privilege, the proxy information ensures that only the minimum required outbound/inbound access is granted to each of compute nodes 104A-104N.

Furthermore, cloud-based agent installation service 114 may create or obtain address information (e.g., a uniform resource locator (URL)) for downloading the agent installer based on user configured agent installation information and proxy information. For example, the agent installation information and the proxy information are user-configured on cloud-based agent installation service 114 running on cloud platform 112.

Further, during operation, second program 118 in management node 116 may fetch agent installation information for installing an agent, the address information for downloading an agent installer, and the proxy information for accessing a proxy server from cloud-based agent installation service 114.

Furthermore, second program 118 may populate shared datastore 108 with the address information and the proxy information using the agent installation information. In an example, second program 118 may populate shared datastore 108 to include the address information and the proxy information as a first key-value pair and a second key-value pair, respectively. The first key-value pair may include a fixed key portion and the address information as a variable value portion. The second key-value pair may include a fixed key portion and the proxy information as a variable value portion.

In an example, second program 118 may identify compute node 104A on which the installation of the agent is to be performed using the agent installation information (e.g., an identifier associated with compute node 104A) and populate shared datastore 108 associated with determined compute node 104A to include the fetched address information and the proxy information.

Furthermore, first program 106A executing on compute node 104A may read the proxy information and the address information from shared datastore 108. Also, first program 106A may read the proxy information and the address information from the shared datastore by periodically polling shared datastore 108 for specific attributes (e.g., the fixed key portion of the first key-value pair and the second key-value pair). Further, first program 106A may download the agent installer from a destination server via the proxy server (e.g., a webserver) based on the address information and the proxy information. Furthermore, first program 106A may initiate an execution of the agent installer to install the agent on compute node 104A. In an example, first program 106A may validate a signature of the downloaded agent installer prior to initiating the execution of the agent installer.

Further, first program 106A may monitor a status of installation of the agent on compute node 104A and update shared datastore 108 to include the monitored status of installation of the agent. In an example, first program 106A may update shared datastore 108 to include the monitored status as a third key-value pair, which includes a fixed key portion and the monitored status as a variable value portion. Furthermore, second program 118 may receive an event notification from compute node 104A or the centralized management platform in response to updating shared datastore 108. In response to receiving the event notification, second program 118 may read the status of installation of the agent from updated shared datastore 108 and send the read status of installation of the agent to cloud-based agent installation service 114. In some examples, the status of installation may be displayed on a graphical user interface (GUI) associated with cloud-based agent installation service 114.

In some examples, the functionalities described in FIG. 1, in relation to instructions to implement functions of first programs 106A-106N, second program 118, cloud-based agent installation service 114, and any additional instructions described herein in relation to the storage medium, may be implemented as engines or modules including any combination of hardware and programming to implement the functionalities of the modules or engines described herein. The functions of first programs 106A-106N, second program 118, and cloud-based agent installation service 114 may also be implemented by a respective processor. In examples described herein, the processor may include, for example, one processor or multiple processors included in a single device or distributed across multiple devices.

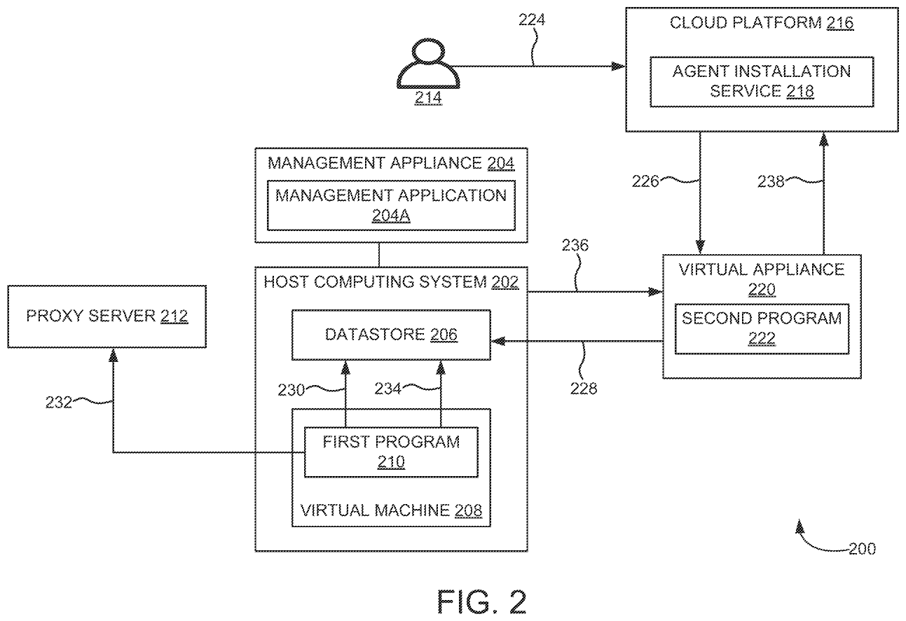

FIG. 2 is a block diagram of an example computing environment 200, depicting a first program 210 to install an agent on a virtual machine 208 based on address information and proxy information. Computing environment 200 may include a host computing system 202. Further, host computing system 202 may include a virtual machine 208 running therein. In an example, virtual machine 208 may include a first program 210 to install the agent on virtual machine 208. For example, first program 210 may be a lightweight process running in virtual machine 208, which can be provided as part of a default package like VMTools, could be bundled inside a template/image from which virtual machine 208 may be deployed/created, or the like.

Further, computing environment 200 may include a datastore 206. In an example, datastore 206 may be deployed as a part of host computing system 202 or connected externally to host computing system 202. Datastore 206 may be accessible to virtual machine 208. In an example, first program 210 may include permissions to read/write data from/to datastore 206 (e.g., which may include GuestInfo attributes) associated with virtual machine 208. First program 210 running in virtual machine 208 may keep polling datastore 206 to check if any data is populated in datastore 206 for specific keys.

Further, computing environment 200 may include a management appliance 204 (physical or virtual). Management appliance 204 may include a management application 204A to manage host computing system 202 and virtual machine 208. An example management application 204A may be vCenter server, which is an advanced server management software that provides a centralized platform for controlling your VMware vSphere environments (e.g., virtual machines, physical host computing systems, and the like).

Further, computing environment 200 may include a virtual appliance 220 communicatively connected to management appliance 204 using a certificate-based authentication and use an appropriate role to be able to perform tasks of reading/writing into datastore 206. Further, virtual appliance 220 may be subscribed to receive events from management appliance 204 in case of any change in information in datastore 206.

Furthermore, virtual appliance 220 may be connected to agent installation service 218, which may be outside of management application's network. Virtual appliance 220 may use secured communication using API tokens to communicate with agent installation service 218 deployed in a cloud platform 216. In an example, virtual appliance 220 may include a second program 222.

During operation, at 224, a user 214 may configure agent information and virtual machine information on agent installation service 218. The virtual machine information may include a target virtual machine identifier and the agent information may include information regarding an agent that has to be installed on the target virtual machine (e.g., 208). In this example, target virtual machine 208 may have to include first program 210 to be eligible for remote installation of agent(s). Further, user 214 may also configure a proxy setting to be used for virtual machine 208. The proxy setting could be management application specific or host computing system specific (i.e., on which virtual machine 208 is executed), based on a network configuration of customer's data center.

Upon receiving the configurations from user 214, agent installation service 218 may create/get a URL (i.e., address information) for downloading an agent installer for installing the agent. At 226, the URL and the proxy setting for virtual machine 208 may be fetched by virtual appliance 220 from agent installation service 218 along with details of virtual machine 208 (e.g., a virtual machine identifier or a virtual machine universally unique identifier) on which the agent has to be installed.

At 228, second program 222 may then use the connection with management application 204A to populate datastore 206 with the specific keys (e.g., which are checked by first program 210) and values as the URL of the agent installer and the proxy settings fetched from agent installation service 218. These keys (e.g., in datastore 206) written by second program 222 may read-only for processes running inside virtual machine 208. This is to ensure that these keys are not tampered with by any process running inside virtual machine 208.

At 230, first program 210 running on virtual machine 208 may poll datastore 206 to read the proxy settings and the URL from datastore 206. At 232, first program 210 may make a call to the internet via a proxy server 212 using the proxy setting and the URL to download the agent installer. Further, first program 210 may then validate a signature of the downloaded agent installer to ensure that the downloaded agent installer is valid and signed. Furthermore, first program 210 may trigger installation of the agent using the downloaded agent installer and track the status of installation.

At 234, upon installation of the agent, first program 210 may update datastore 206 with the status of the installation using another key-value pair. At 236, virtual appliance 220 may get notification of any change in datastore 206. Further, virtual appliance 220 may check for the status of installation using data in datastore 206 as populated by first program 210 and then update agent installation service 218 with the status of agent installation, at 238.

Thus, examples described herein may provide an approach to install any number of agents using a lightweight process (i.e., first program 210) present on virtual machine 208. Further, any subsequent changes in version or the agent to be installed or number of agents to be installed can be managed using agent installation service 218 without requiring any change on virtual machine 208 running or to be restarted.

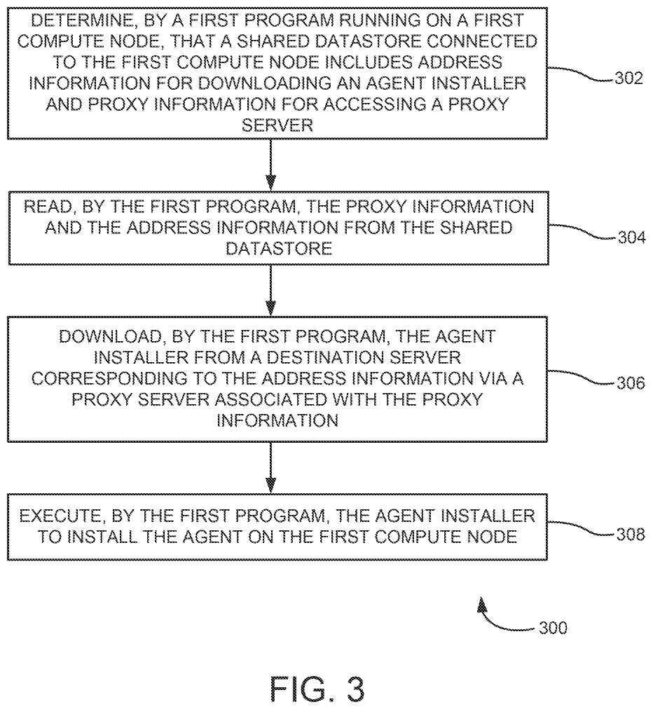

FIG. 3 is a flow diagram illustrating an example computer-implemented method 300 for installing an agent on a first compute node in a data center. The first compute node may include a virtual machine running on a physical host computing system or a container running on the physical host computing system in the data center. At 302, a check may be made by a first program running on the first compute node to determine that a shared datastore connected to the first compute node includes address information for downloading an agent installer and proxy information for accessing a proxy server. The agent installation information and the proxy information may be user-configured on a cloud-based agent installation service running on a cloud computing platform. In an example, the address information and the proxy information may be stored in the shared datastore by a second program running on a second compute node based on a user-configured input. In an example, determining that the shared datastore includes the address information and the proxy information may be performed via polling the shared datastore. Further, the address information and the proxy information populated in the shared datastore may be read-only for processes running in the first compute node. The address information may include a uniform resource allocator (URL), for instance.

In an example, the agent installation information for installing the agent, the address information, and the proxy information may be fetched, by the second program running on the second compute node, from the cloud-based agent installation service. Further, the first compute node on which the installation of the agent is to be performed may be determined by the second program using the agent installation information. Furthermore, the shared datastore associated with the determined first compute node may be populated with the address information and the proxy information by the second program.

At 304, the proxy information and the address information may be read by the first program from the shared datastore in response to determining that the shared datastore includes the address information and the proxy information. At 306, the agent installer may be downloaded by the first program from a destination server corresponding to the address information via a proxy server associated with the proxy information. At 308, the agent installer may be executed by the first program to install the agent on the first compute node. In an example, a signature of the downloaded agent installer may be validated by the first program prior to initiating the execution of the agent installer.

Further, method 300 may include monitoring, by the first program, a status of installation of the agent on the first compute node and updating, by the first program, the shared datastore to include the monitored status of installation of the agent. Furthermore, method 300 may include receiving, by the second program, an event notification from the first compute node in response to updating the shared datastore. The second compute node may be subscribed to receive events associated with any change in attributes corresponding to the shared datastore. Further, method 300 may include reading, by the second program, the status of installation of the agent from the updated shared datastore in response to receiving the event notification. Furthermore, method 300 may include sending, by the second program, the read status of installation of the agent to the cloud-based agent installation service.

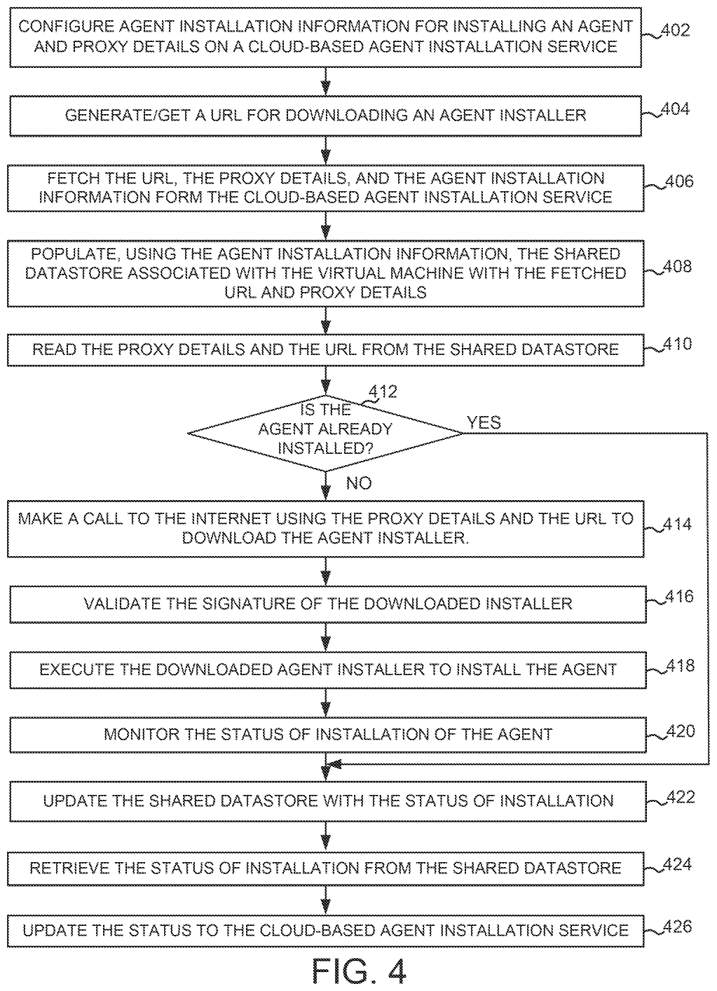

FIG. 4 is a flow diagram illustrating another example computer-implemented method 400 for installing an agent on a virtual machine in a data center. At 402, agent installation information for installing an agent and proxy details may be configured by a user on a cloud-based agent installation service. At 404, a URL for downloading an agent installer may be generated or obtained by the cloud-based agent installation service.

At 406, the URL, the proxy details, and the agent installation information (e.g., virtual machine identifier) may be fetched by a virtual appliance from the cloud-based agent installation service. At 408, the shared datastore, associated with the virtual machine, may be populated with the fetched URL and the proxy details using the agent installation information by the virtual appliance. In an example, the shared datastore may be shared between and accessible to the virtual appliance and the virtual machine.

At 410, the proxy details and the URL may be read from the shared datastore by the virtual machine via polling the shared datastore. At 412, a check may be made to determine whether the agent is already installed in the virtual machine. When the agent is not installed in the virtual machine, at 414, a call may be made to the internet using the proxy details and the URL to download the agent installer by the virtual machine.

At 416, the signature of the downloaded installer may be validated by the virtual machine. At 418, the downloaded agent installer may be executed to install the agent by the virtual machine upon validating the signature of the downloaded installer. At 420, the status of installation of the agent may be monitored by the virtual machine. At 422, the shared datastore may be updated with the status of installation by the virtual machine.

At 424, the status of installation from the shared datastore may be retrieved by the virtual appliance in response to receiving an event notification from the virtual machine or a management application that manages the virtual machine. At 426, the cloud-based agent installation service may be updated with the status of installation by the virtual appliance. When the agent is already installed in the virtual machine, the process goes to 422 to update the shared datastore with the status of installation by the virtual machine.

Example methods 300 and 400 depicted in FIGS. 3 and 4 represent generalized illustrations, and other processes may be added, or existing processes may be removed, modified, or rearranged without departing from the scope and spirit of the present application. In addition, methods 300 and 400 may represent instructions stored on a computer-readable storage medium that, when executed, may cause a processor to respond, to perform actions, to change states, and/or to make decisions. Alternatively, methods 300 and 400 may represent functions and/or actions performed by functionally equivalent circuits like analog circuits, digital signal processing circuits, application specific integrated circuits (ASICs), or other hardware components associated with the system. Furthermore, the flow charts are not intended to limit the implementation of the present application, but the flow chart illustrates functional information to design/fabricate circuits, generate computer-readable instructions, or use a combination of hardware and computer-readable instructions to perform the illustrated processes.

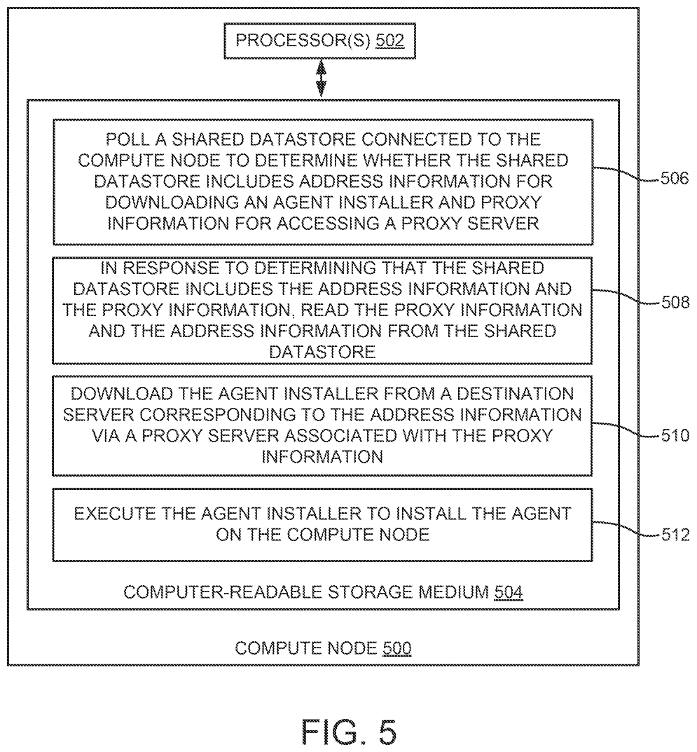

FIG. 5 is a block diagram of an example compute node 500 including non-transitory computer-readable storage medium 504 storing instructions to install an agent on compute node 500. Compute node 500 may include a processor 502 and computer-readable storage medium 504 communicatively coupled through a system bus. Processor 502 may be any type of central processing unit (CPU), microprocessor, or processing logic that interprets and executes computer-readable instructions stored in computer-readable storage medium 504. Computer-readable storage medium 504 may be a random-access memory (RAM) or another type of dynamic storage device that may store information and computer-readable instructions that may be executed by processor 502. For example, computer-readable storage medium 504 may be synchronous DRAM (SDRAM), double data rate (DDR), Rambus® DRAM (RDRAM), Rambus® RAM, etc., or storage memory media such as a floppy disk, a hard disk, a CD-ROM, a DVD, a pen drive, and the like. In an example, computer-readable storage medium 504 may be a non-transitory computer-readable medium. In an example, computer-readable storage medium 504 may be remote but accessible to compute node 500.

Computer-readable storage medium 504 may store instructions 506, 508, 510, and 512. Instructions 506 may be executed by processor 502 to poll a shared datastore connected to compute node 500 to determine whether the shared datastore includes address information for downloading an agent installer and proxy information for accessing a proxy server. In an example, the proxy information and the address information may be populated in the shared datastore as key-value pairs. For example, a first key-value pair may include a fixed key portion and the address information as a variable value portion. Further, a second key-value pair may include a fixed key portion and the proxy information as a variable value portion.

Instructions 508 may be executed by processor 502 to read the proxy information and the address information from the shared datastore in response to determining that the shared datastore includes the address information and the proxy information. In an example, computer-readable storage medium 504 may store instructions to deploy a first program in compute node 500 and enable the first program to read/write data from/to the shared datastore associated with compute node 500.

Instructions 510 may be executed by processor 502 to download the agent installer from a destination server corresponding to the address information via a proxy server associated with the proxy information. In an example, instructions 510 to download the agent installer may include instructions to determine if compute node 500 includes the agent and download the agent installer from the destination server in response to determining that the agent is not installed on compute node 500. Instructions 512 may be executed by processor 502 to execute the agent installer to install the agent on compute node 500.

Further, computer-readable storage medium 504 may store instructions to monitor a status of installation of the agent on compute node 500 and update the shared datastore to include the monitored status of installation of the agent. Further, computer-readable storage medium 504 may store instructions to notifying a subscription-based service such that the subscription-based service is to retrieve the status of installation of the agent from the updated shared datastore upon updating the shared datastore.

The above-described examples are for the purpose of illustration. Although the above examples have been described in conjunction with example implementations thereof, numerous modifications may be possible without materially departing from the teachings of the subject matter described herein. Other substitutions, modifications, and changes may be made without departing from the spirit of the subject matter. Also, the features disclosed in this specification (including any accompanying claims, abstract, and drawings), and any method or process so disclosed, may be combined in any combination, except combinations where some of such features are mutually exclusive.

The terms “include,” “have,” and variations thereof, as used herein, have the same meaning as the term “comprise” or appropriate variation thereof. Furthermore, the term “based on”, as used herein, means “based at least in part on.” Thus, a feature that is described as based on some stimulus can be based on the stimulus or a combination of stimuli including the stimulus. In addition, the terms “first” and “second” are used to identify individual elements and may not meant to designate an order or number of those elements.

The present description has been shown and described with reference to the foregoing examples. It is understood, however, that other forms, details, and examples can be made without departing from the spirit and scope of the present subject matter that is defined in the following claims.

What is claimed is:

1. A method comprising:
determining, by a first program running on a first compute node in a data center, that a shared datastore connected to the first compute node includes address information for downloading an agent installer and proxy information for accessing a proxy server, wherein the address information and the proxy information are stored in the shared datastore by a second program running on a second compute node based on a user-configured input;
in response to determining that the shared datastore includes the address information and the proxy information, reading, by the first program, the proxy information and the address information from the shared datastore;
downloading, by the first program, the agent installer from a destination server corresponding to the address information via a proxy server associated with the proxy information; and
executing, by the first program, the agent installer to install the agent on the first compute node.

2. The method of claim 1, wherein determining that the shared datastore includes the address information and the proxy information comprises:
determining that the shared datastore includes address information and proxy information via polling the shared datastore.

3. The method of claim 1, further comprising:
fetching, by the second program running on the second compute node, the agent installation information for installing the agent, the address information, and the proxy information from a cloud-based agent installation service;
determining, by the second program, the first compute node on which the installation of the agent is to be performed using the agent installation information; and
populating, by the second program, the shared datastore associated with the determined first compute node with the address information and the proxy information.

4. The method of claim 1, further comprising:
monitoring, by the first program, a status of installation of the agent on the first compute node; and
updating, by the first program, the shared datastore to include the monitored status of installation of the agent.

5. The method of claim 4, further comprising:
receiving, by the second program, an event notification from the first compute node in response to updating the shared datastore, wherein the second compute node is subscribed to receive events associated with any change in attributes corresponding to the shared datastore;
in response to receiving the event notification, reading, by the second program, the status of installation of the agent from the updated shared datastore; and
sending, by the second program, the read status of installation of the agent to the cloud-based agent installation service.

6. The method of claim 1, further comprising:
prior to initiating the execution of the agent installer, validating, by the first program, a signature of the downloaded agent installer.

7. The method of claim 1, wherein the first compute node comprises a virtual machine running on a physical host computing system or a container running on the physical host computing system.

8. The method of claim 1, wherein the agent installation information and the proxy information are user-configured on a cloud-based agent installation service running on a cloud computing platform.

9. The method of claim 1, wherein the address information and the proxy information populated in the shared datastore are read-only for processes running in the first compute node.

10. The method of claim 1, wherein the address information comprises a uniform resource allocator (URL).

11. A system comprising:
a compute node executing a first program;
a management node connected to the compute node and a cloud-based agent installation service; and
a shared datastore accessible to the compute node and the management node, wherein the management node comprises a second program to:
fetch, from the cloud-based agent installation service, agent installation information for installing an agent, address information for downloading an agent installer, and proxy information for accessing a proxy server; and
populate, using the agent installation information, the shared datastore with the address information and the proxy information,
wherein the first program is to:
read the proxy information and the address information from the shared datastore;
download the agent installer from a destination server via the proxy server based on the address information and the proxy information; and
initiate an execution of the agent installer to install the agent on the compute node.

12. The system of claim 11, wherein the first program is to:
monitor a status of installation of the agent on the compute node; and
update the shared datastore to include the monitored status of installation of the agent.

13. The system of claim 12, wherein the second program is to:
receive an event notification from the compute node in response to updating the shared datastore;
in response to receiving the event notification, read the status of installation of the agent from the updated shared datastore; and
send the read status of installation of the agent to the cloud-based agent installation service.

14. The system of claim 11, wherein the first program is to:
prior to initiating the execution of the agent installer, validate a signature of the downloaded agent installer.

15. The system of claim 11, wherein the second program is to:
identify the compute node on which the installation of the agent is to be performed using the agent installation information; and
populate the shared datastore associated with the determined compute node to include the fetched address information and the proxy information.

16. The system of claim 11, wherein the second program is to:
populate the shared datastore to include the address information and the proxy information as a first key-value pair and a second key-value pair, respectively, wherein the first key-value pair includes a fixed key portion and the address information as a variable value portion, and wherein the second key-value pair includes a fixed key portion and the proxy information as a variable value portion.

17. The system of claim 11, wherein the compute node comprises one of a physical host computing system, a virtual machine running on the physical host computing system, or a container running on the physical host computing system.

18. The system of claim 11, wherein the first program is to:
read the proxy information and the address information from the shared datastore by periodically polling the shared datastore for specific attributes.

19. The system of claim 11, wherein the agent installation information and the proxy information are user-configured on the cloud-based agent installation service running on a cloud computing platform.

20. The system of claim 11, wherein the cloud-based agent installation service is to create or obtain the address information for downloading the agent installer based on the user configured agent installation information and proxy information.

21. The system of claim 11, wherein the management node is to communicate with the compute node using a certificate-based authentication to read/write data to the shared datastore.

22. The system of claim 11, wherein the management node is to securely communicate with the cloud-based agent installation service using application programming interface (API) tokens.

23. A non-transitory computer-readable storage medium encoded with instructions that, when executed by a processor of a compute node in a data center, cause the processor to:
poll a shared datastore connected to the compute node to determine whether the shared datastore includes address information for downloading an agent installer and proxy information for accessing a proxy server;
in response to determining that the shared datastore includes the address information and the proxy information, read the proxy information and the address information from the shared datastore;
download the agent installer from a destination server corresponding to the address information via a proxy server associated with the proxy information; and
execute the agent installer to install the agent on the compute node.

24. The non-transitory computer-readable storage medium of claim 23, further comprising instructions to:
monitor a status of installation of the agent on the compute node;
update the shared datastore to include the monitored status of installation of the agent; and
upon updating the shared datastore, notify a subscription-based service such that the subscription-based service is to retrieve the status of installation of the agent from the updated shared datastore.

25. The non-transitory computer-readable storage medium of claim 23, further comprising instructions to:
deploy the first program in the compute node; and
enable the first program to read/write data from/to the shared datastore associated with the compute node.

26. The non-transitory computer-readable storage medium of claim 23, wherein the proxy information and the address information are populated in the shared datastore as key-value pairs, wherein a first key-value pair includes a fixed key portion and the address information as a variable value portion, and wherein a second key-value pair includes a fixed key portion and the proxy information as a variable value portion.

27. The non-transitory computer-readable storage medium of claim 23, wherein instructions to download the agent installer comprise instructions to:
determine if the compute node includes the agent; and
in response to determining that the agent is not installed on the compute node, download the agent installer from the destination server.
